(19) United States
(12) Patent Application Publication
(10) Pub. No.: US 2018/0318841 A1
(43) Pub. Date: Nov. 8, 2018

(54) ROLLER PRESS WITH BOLTLESS EDGE WEAR COMPONENTS AND A METHOD FOR SECURING THE SAME

(71) Applicant: FLSmidth A/S, Valby (DK)

(72) Inventors: David Dustin Udy, Layton, UT (US); Johann Hans Knecht, Wadersloh (DE)

(21) Appl. No.: 15/962,579

(22) Filed: Apr. 25, 2018

(30) Foreign Application Priority Data
May 2, 2017 (DK) PA 2017 70291

(51) Int. Cl. B02C 4/30

(52) U.S. Cl. CPC B02C 4/305; B02C 2210/02

(57) ABSTRACT

A roller press comprises a roller having a roller edge; an edge wear component provided adjacent to the roller edge, the edge wear component further comprising a wear portion, an anchor portion and a connection portion; an anchor mounting pocket configured to receive the anchor portion; a gap configured to receive autogenous or semi-autogenous crushed material, the gap provided within the roller adjacent to an inner face of the edge wear component, the gap running substantially parallel to an inner face of the edge wear component and the gap configured to receive autogenous or semi-autogenous crushed material; wherein the autogenous or semi-autogenous material is disposed within the gap and the anchor portion is disposed within the anchor mounting pocket to secure the edge wear component to the roller. Also disclosed, is a method of mounting an edge wear component to a roller using such an arrangement.

### FIELD OF THE INVENTION

This invention relates to crushing, grinding, and comminution equipment, and more particularly to high pressure grinding roller (HPGR) press systems used, for instance, in the mining, cement, and minerals industries.

### BACKGROUND OF THE INVENTION

Roller mills grind material by drawing the material into a roller nip formed by two counter-rotating grinding rollers that are separated from each other and subject to a pressurized force. The material being ground passes between the nip formed between the grinding rollers. The outer surface of each of the grinding rollers is thus subject to substantial wear. In addition to the outer surface of each of the grinding rollers, the end faces (or roller ends) of the grinding rollers and the transitional edge between the outer surface and the end faces of the grinding rollers are also subjected to a high level of wear during the continued pressure comminution of material. It is known to provide different types of reinforced edge wear components to the rollers to reduce the amount of wear on the grinding rollers and to prevent crushed material from being squeezed out of the sides of the rollers.

Existing edge wear components typically require fasteners, such as bolts or screws, and are thus a high cost item for such grinding machines due to e.g. material costs of wasted high cost wear materials and fasteners and due to labor costs for machining tapped holes and the assembly/disassembly of such fasteners when e.g. installing or changing out rollers. Moreover, existing rollers with edge wear components requiring fasteners are difficult to refurbish (due to improper fastener hole placement) and require complex tools for removal. Additionally, such fasteners provide a relatively weak connection of the edge wear components to the roller because autogenous or semi-autogenous material gradually packs in between the edge segments and the side of the roller and over time a high force back and forth cantilevering action can fatigue the fasteners and cause the joint to fail over time. Such prior art solutions can be found in e.g. U.S. Pat. Nos. 6,454,687, 7,497,396, 8,833,687; WO Publication Nos. 2014/071173 and 2013/101475 and US Patent Publication No. US 2013/0277481.

It will be clearly understood that any reference herein to background material or information, or to a prior patent or publication, does not constitute an admission that any material, information, patent or publication forms part of the common general knowledge in the art, or is otherwise admissible prior art.

### OBJECT OF THE INVENTION

It is an object of the invention to overcome or at least alleviate one or more of the above problems and/or provide the consumer with a useful or commercial choice.

### SUMMARY OF THE INVENTION

A roller is provided for crushing particulate material which may include a roller having a roller edge formed by the intersection of a roller end and an outer surface; an edge wear component provided adjacent to the roller edge, the edge wear component further comprising a wear portion, an anchor portion and a connection portion, the wear portion connected to the anchor portion via a connection portion disposed between the wear portion and the anchor portion; an anchor mounting pocket located inland of the roller end and being spaced from the roller edge and provided within the roller, the anchor mounting pocket being configured to receive the anchor portion, the anchor mounting pocket being generally isolated from the roller end; a gap located inland of the roller end and being spaced from the roller edge and provided within the roller adjacent to an inner face of the edge wear component, the gap running substantially parallel to an inner face of the edge wear component and the gap configured to receive autogenous or semi-autogenous crushed material wherein the autogenous or semi-autogenous material is disposed within the gap and the anchor portion is disposed within the anchor mounting pocket to secure the edge wear component to the roller.

In an exemplary embodiment, at least a portion of the inner face of the edge wear component may be tapered. In another exemplary embodiment, at least a portion of a second face of the anchor portion is tapered in a direction opposite to the taper of the inner face of the edge wear component or a first face of the anchor portion.

A weld material may be disposed on an outer face of the edge wear component to further secure the edge wear component to the roller and to reduce or eliminate lateral shifting.

In an exemplary embodiment, securing material may be disposed within the gap or the anchor mounting pocket to further secure the edge wear component to the roller. In some embodiment, the securing material may be glue or epoxy.

In an exemplary embodiment, the anchor portion and the connection portion may be a unitary piece and the wear portion may be separate from the unitary anchor portion and connection portion. The unitary anchor portion and connection portion may be connected to the wear portion via a brazing, welding, soldering, sintering, hot isostatic pressing powdered metallurgy, hot forging, warm compacting, powder forging, metal injection molding, high temperature process, interference fit pressing, gluing, or other means for mechanical bonding. In some embodiments, the connection portion may comprise a key and the wear portion may comprise a keyway, wherein the key and keyway connect the anchor portion via the connection portion to the wear portion by interference fit pressing.

In an exemplary embodiment, the edge wear component may comprise a composite material.

A method of securing an edge wear component to a roller in a roller press is also provided. Such a method may comprise: providing a roller having a roller edge formed by the intersection of a roller end and an outer surface with an anchor mounting pocket located inland of the roller end and being spaced from the roller edge, the anchor mounting pocket being configured to receive an anchor portion, the anchor mounting pocket being generally isolated from the roller end [3]; providing an edge wear component adjacent to the roller edge, the edge wear component further comprising a wear portion, an anchor portion and a connection portion, the wear portion connected to the anchor portion via a connection portion being disposed between the wear portion and the anchor portion; providing a gap located inland of the roller end and being spaced from the roller edge and provided within the roller adjacent to an inner face of the edge wear component, the gap running substantially parallel to an inner face of the edge wear component and the gap configured to receive autogenous or semi-autogenous crushed material; positioning the edge wear component adjacent the roller edge; positioning the anchor portion within the anchor mounting pocket; providing autogenous or semi-autogenous material within the gap; and fixing the edge wear component to the roller.

The method may further comprise the step of providing a weld material on an outer face of the edge wear component. The method may further comprise providing a securing material within the gap or the anchor mounting pocket.

In some embodiments, the step of providing an edge wear component adjacent to the roller edge the edge wear component further comprising a wear portion, an anchor portion and a connection portion, the wear portion connected to the anchor portion via a connection portion being disposed between the wear portion and the anchor portion may further comprise connecting the wear portion to the connection portion or the anchor portion to the connection portion by brazing, welding, soldering, sintering, hot isostatic pressing powdered metallurgy, hot forging, warm compacting, powder forging, metal injection molding, high temperature process, interference fit pressing, gluing, or other means for mechanical bonding.

Other details, objects, and advantages of the invention will become apparent as the following description of certain present exemplary embodiments thereof and certain present exemplary methods of practicing the same proceeds.

### BRIEF DESCRIPTION OF THE DRAWINGS

Present embodiments of a roller for the crushing of particulate material, and edge wear components for the same, are shown in the accompanying drawings.

FIG. 1 shows a three-dimensional model of an overview of a roller according to an exemplary embodiment of the invention.

FIG. 2 shows a cross-sectional view of a roller according to a first exemplary embodiment of the invention.

FIG. 3 shows a top angled cross-sectional view of a roller according to the first exemplary embodiment of the invention.

FIG. 4 shows a top angled cross-sectional view of a roller according to a second exemplary embodiment of the invention.

FIG. 5 shows a top angled cross-sectional view of a roller according to a third exemplary embodiment of the invention.

FIG. 6 shows a cross-sectional view of a roller according to a fourth exemplary embodiment of the invention.

FIG. 7 shows a cross-sectional view of a roller according to a fifth exemplary embodiment of the invention.

FIG. 8 shows a top angled cross-sectional view of a roller according to a sixth exemplary embodiment of the invention.

FIG. 9 shows a top cross-sectional view of a roller and the edge wear components according to a seventh exemplary embodiment of the invention.

FIG. 10 shows a cross-sectional view of a roller according to an eighth exemplary embodiment of the invention.

### DETAILED DESCRIPTION OF THE INVENTION

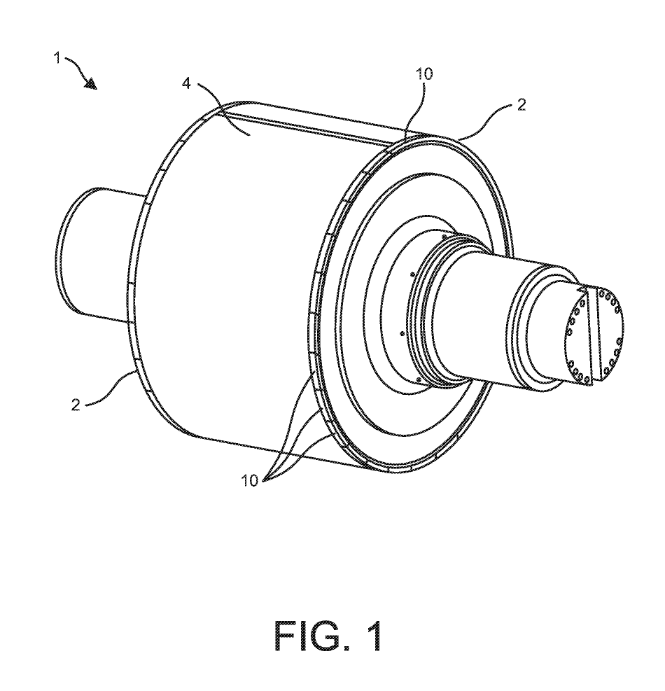

Referring to FIGS. 1 through 10, a roller for crushing, grinding, and comminution equipment has a roller edge (2) which is formed by the intersection of a roller end (3) and an outer surface (4) of the roller. FIG. 1 depicts a roller (1) of a high pressure grinding roller (HPGR) press system used, for instance, in the mining, cement, and minerals industries. Material can be crushed on the outer surface (4) of the roller (1) between the nip formed between two grinding rollers (1). Edge wear components (10) are provided on the roller edge (2) to reduce the amount of wear on the roller edges (2) and roller ends (3) and to prevent crushed material from being squeezed out the sides of the roller (1).

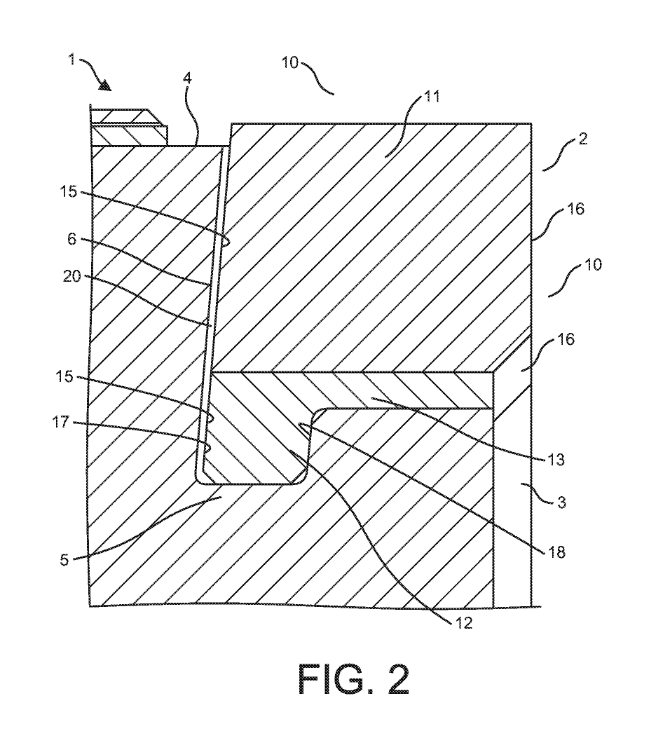

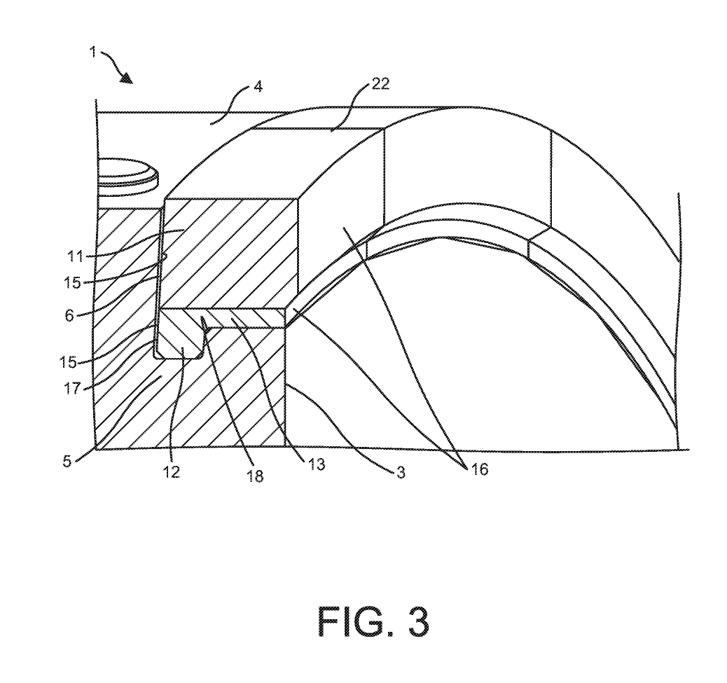

As shown in FIGS. 2 and 3 edge wear components (10) may be provided adjacent to the roller edge (2). In one embodiment, the edge wear component (10) is comprised of a wear portion (11), an anchor portion (12) and a connection portion (13). The wear portion (11) is connected to the anchor portion (12) via a connection portion (13) which is disposed between the wear portion (11) and the anchor portion (12). An anchor mounting pocket (5) is located inland of the roller end (3) and is spaced from the roller edge (2) and provided within the roller (1). The anchor mounting pocket (5) is configured to receive the anchor portion (12). The anchor mounting pocket (5) is generally isolated from the roller end (3). The anchor mounting pocket (5) and anchor mounting portion (12) can be different shapes, e.g. those shown in FIGS. 2-8, 10.

A gap (6) is also provided in the roller (1). The gap (6) is located inland of the roller end (3) and is spaced from the roller edge (2). The gap (6) is provided within the roller (1) and is located adjacent to an inner face (15) of the edge wear component (10). The gap (6) may run substantially parallel to the inner face (15) of the edge wear component (10). The gap (6) is configured to receive autogenous or semi-autogenous crushed material (20). In some embodiments, the gap (6) extends vertically along the entire inner face (15) of the edge wear component (10). In other embodiments, the gap may extend vertically along only a portion of the inner face (15) of the edge wear component (10). For example, the gap (6) may extend vertically along the entire inner face (15) of the wear portion (11) and only partially along the first face (17) of the anchor portion (12). In some embodiments, the gap (6) may extend partially (as shown in FIG. 2) or fully (not shown) underneath the bottom face or bottom corner of the anchor portion (12).

The autogenous or semi-autogenous material (20) can be disposed within the gap (6) to secure the edge wear component (10) to the roller (1). Further, the anchor portion (12) may be disposed within the anchor mounting pocket (5) to secure the edge wear component (10) to the roller (1). In some embodiments, a securing material may also be disposed within the gap (6) or the anchor mounting pocket (5) to further secure the edge wear component (10) to the roller (1). In some embodiments the securing material is glue or epoxy. In other embodiments the securing material may be cast urethane, plastic or rubber. In some embodiments the securing material is placed in the gap (6) to initially secure the edge wear components (10) to the roller (1). When the roller (1) is in use, some or all of the securing material may eventually erode, melt or become displaced or dislodged and soon thereafter be replaced partially or fully by autogenous or semi-autogenous material (20) which will provide a more permanent means for securing the edge wear components (10) to the roller (1).

In some embodiments, the entire inner face (15) of the edge wear component (10) is vertically aligned. However, in other embodiments the first face of the anchor portion (17) can be offset from the inner face of the wear portion (11) and/or the inner face of the connection portion (13); or vice versa.

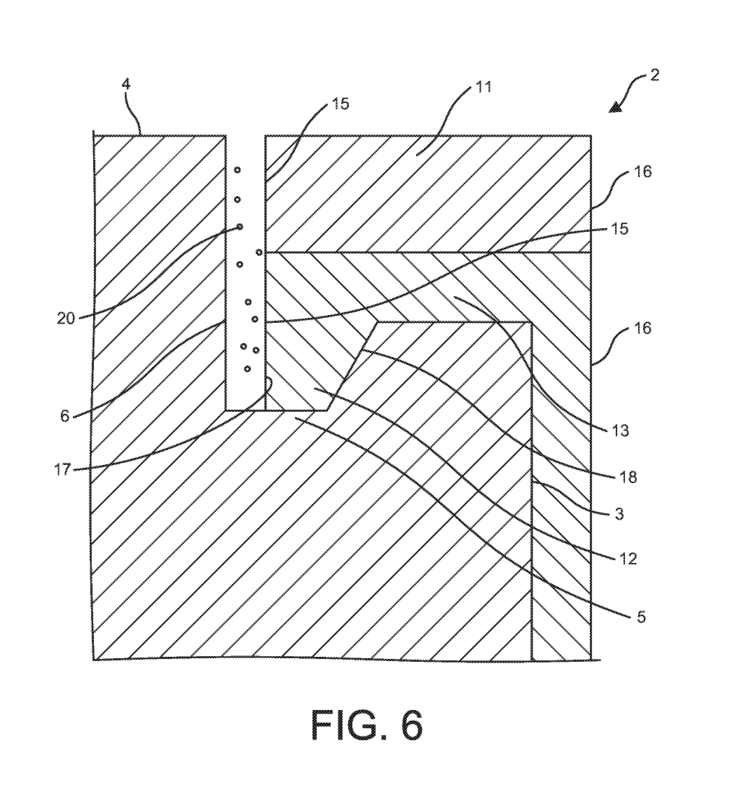

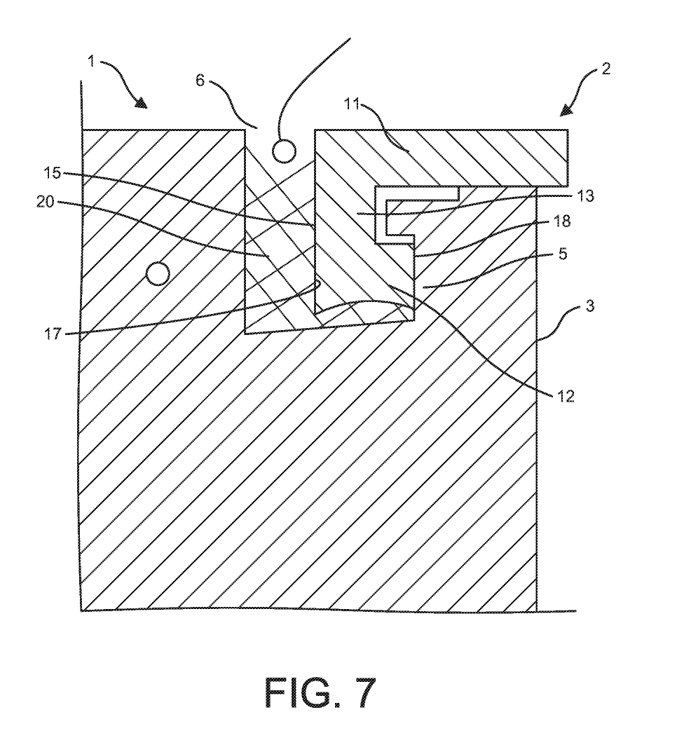

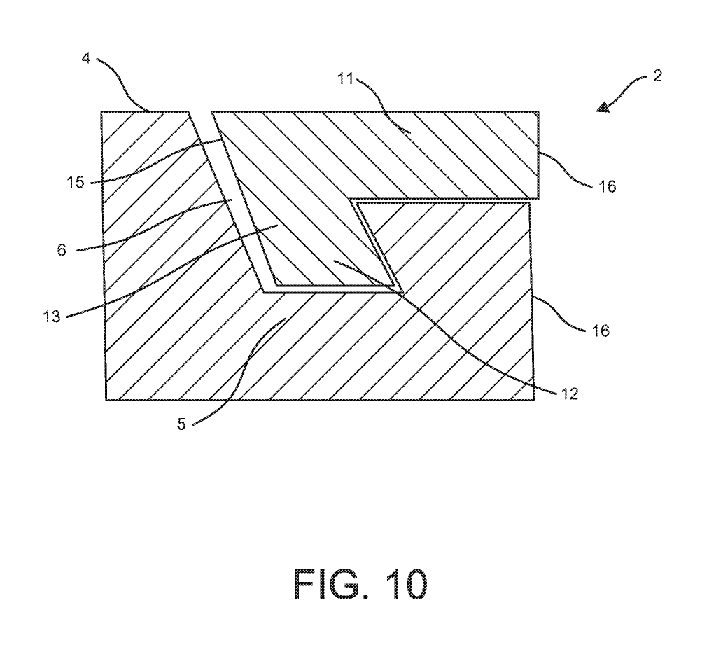

In some embodiments, and as shown in e.g. FIGS. 2 and 3, at least a portion of the inner face (15) of the edge wear component (10) is tapered. In some embodiments, a portion of a second face (18) of the anchor portion (12) may be reverse tapered in a direction opposite to the taper of the inner face (15) of the edge wear component (10). Such tapering assists in locking the anchor portion (12) of the edge wear component (10) to the roller (1). In other embodiments, and as shown in FIGS. 6 and 7, the inner face (15) of the edge wear component (10) is not-tapered but is instead straight, meaning that it is substantially parallel to the roller edge (3). In some embodiments, for example as shown in FIG. 6, only the second face (18) of the anchor portion (12) is tapered. In other embodiments, for example as shown in FIG. 7, the second face (18) of the anchor portion (12) is not tapered, instead it is straight. In other embodiments, for example as shown in FIG. 10, the inner face (15) of the edge wear component (10) and the second face (18) of the anchor portion are tapered in the same direction.

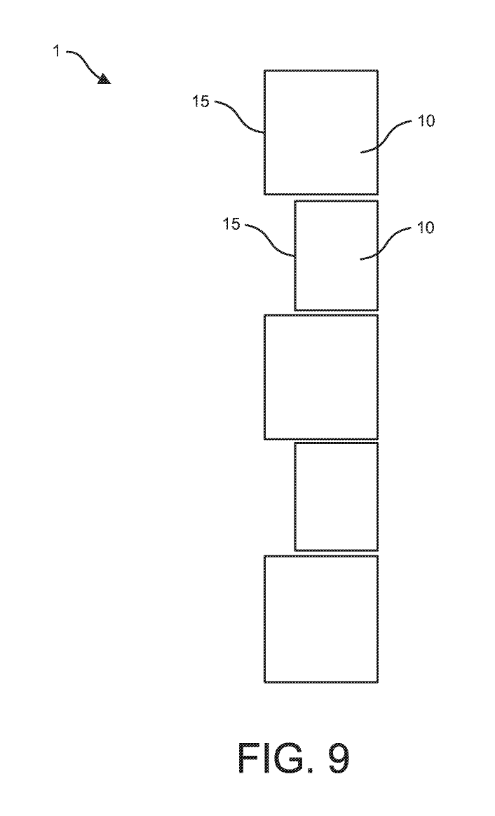

In some embodiments, and as shown in e.g. FIG. 9, the inner faces (15) of adjacent edge wear components (10) are offset from each other. Such offsetting of the inner faces (15) of adjacent wear components help to prevent the wear components (10) from circumferentially slipping.

In some embodiments the anchor portion (12) and the connection portion (13) are a pre-fabricated unitary piece and the wear portion (11) is a separate pre-fabricated piece. In other embodiments the anchor portion (12) and the connection portion (13) may be fabricated as separate pieces. In yet other embodiments, the wear portion (11), the anchor portion (12) and the connection portion (13) are a pre-fabricated unitary piece. In exemplary embodiments, the wear portion (11) can be connected to the connection portion (13) or the anchor portion (12) can be connected to the connection portion (13) by brazing, welding, soldering, sintering, hot isostatic pressing powdered metallurgy, hot forging, warm compacting, powder forging, metal injection molding, high temperature process, interference fit pressing, gluing, or other means for mechanical bonding.

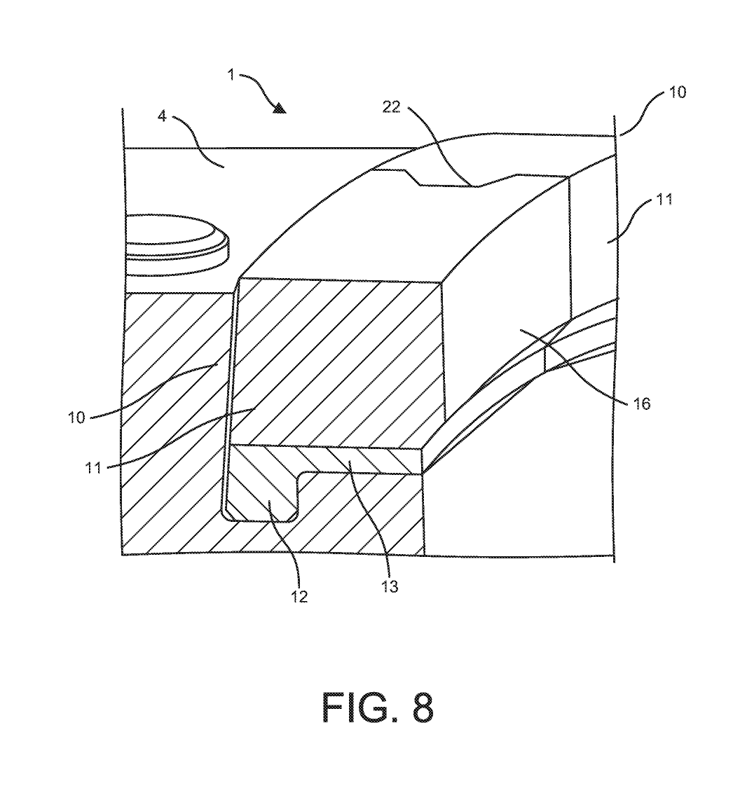

As shown in FIG. 8, in some embodiments, the forward and back faces of the wear portion (11), the connection portion (13) and/or the anchor portion (12) of the wear components (10) may be non-uniform so that the edge wear components can be interlocked at the interface (22) between edge wear components (10). Alternatively, in some embodiments, as shown e.g. in FIG. 3, the interface (22) between edge wear components is substantially straight.

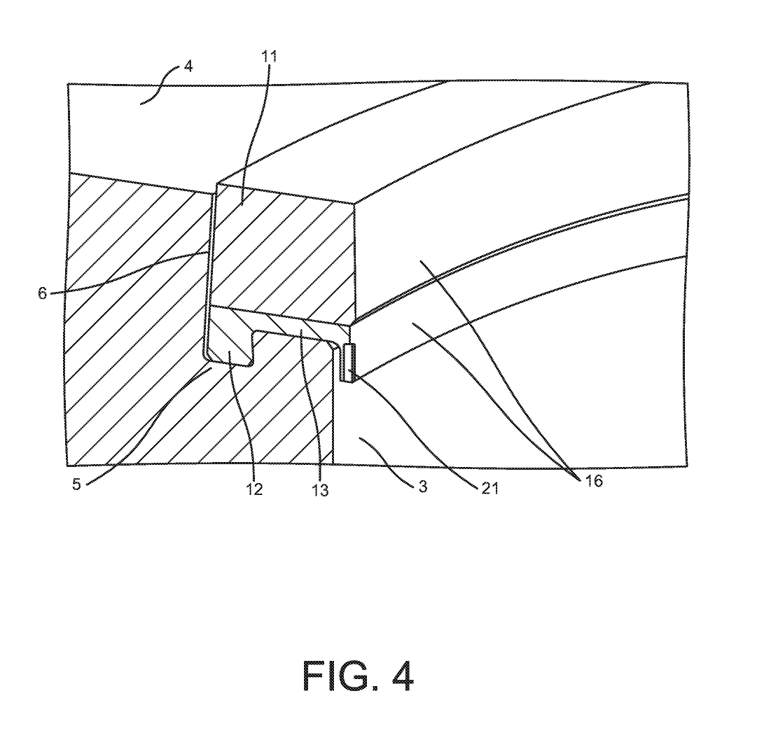

As shown in FIG. 4, in some embodiments, a weld material (21) can be disposed on an outer face (16) of the edge wear component (10). The weld material further secures the edge wear component (10) to the roller (1) and reduces or eliminates lateral and/or circumferential shifting of the edge wear components (10).

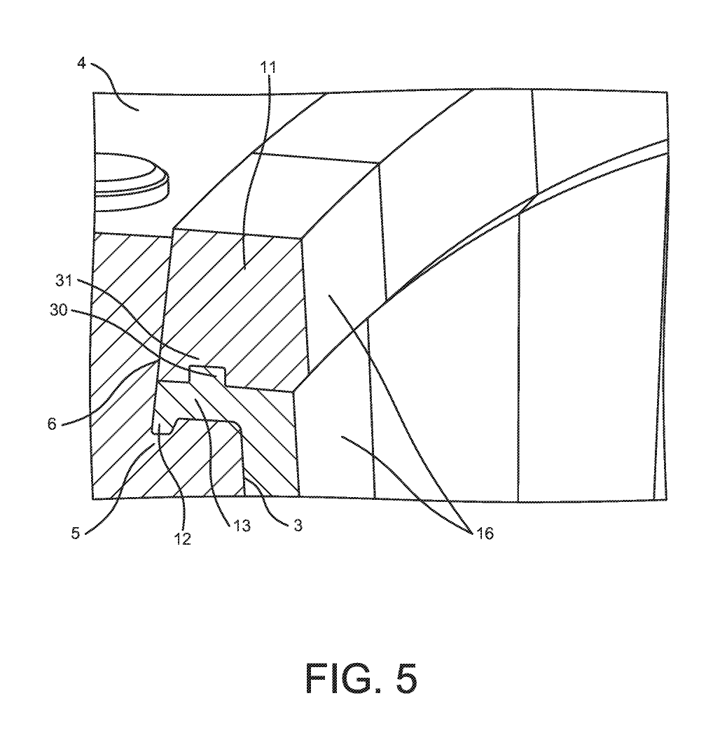

As shown in FIG. 5, in some embodiments, the connection portion may be comprised of a key (30) and the wear portion (11) may be comprised of a keyway (31). The key (30) and keyway (31) may be connected by e.g. an interference fit to connect the anchor portion (12), via the connection portion (13), to the wear portion (11).

The wear portion (11) is typically exposed to the material to be ground and therefore it can be made of a highly resistant wear material. For example, the wear portion (10) can be made of tungsten carbide. The anchor portion (12) and the connection portion (13) can be made of the same material as the wear portion (11) or be made of different materials (i.e.—the edge wear components (10) can be comprised of a composite material). Because the anchor portion (12) and connection portion (13) are not directly exposed to the material to be ground, in some embodiments such portions are made of traditional (and less expensive) wear surfaces (for example steel, cast iron, austempered ductile iron, carbidic austempered ductile iron or polyurethane).

A method for mounting an edge wear component (10) to a roller (1) according to the invention is also disclosed. In an exemplary embodiment, the method comprises the steps of: providing a roller (1) according to the invention; providing an edge wear component (10) according to the invention adjacent to a roller edge (2); providing a gap (6) located inland of a roller end (3) and being spaced from the roller edge (2) and provided within the roller (1) adjacent to an inner face (15) of the edge wear component (10), the gap (6) running substantially parallel to an inner face (15) of the edge wear component (10) and the gap configured to receive autogenous or semi-autogenous crushed material (20); positioning the edge wear component (10) adjacent to the roller edge [2]; positioning the anchor portion (12) within the anchor mounting pocket (5); providing autogenous or semi-autogenous material (20) within the gap; and fixing the edge wear component (10) to the roller (1).

In another embodiment, the method further comprises the step of providing a weld material on an outer face (16) of the edge wear component (10).

In another embodiment, the method further comprises providing a securing material within the gap (6) or the anchor mounting pocket (5).

In yet another embodiment, the step of providing an edge wear component (10) further comprises connecting the wear portion (11) to the connection portion (13) or the anchor portion (12) to the connection portion (13) by brazing, welding, soldering, sintering, hot isostatic pressing powdered metallurgy, hot forging, warm compacting, powder forging, metal injection molding, high temperature process, interference fit pressing, gluing, or other means for mechanical bonding.

The invention disclosed herein eliminates the need for fasteners in order to attach edge wear segments to a roller. Eliminating fasteners is very advantageous in that it may e.g. reduce the costs of the rollers and machines by e.g. reducing material costs and by reducing labor costs (i.e.—the costs associated with machining tapped fastener holes and the assembly/disassembly of such fasteners).

The present invention also allows for the edge wear components to be securely fastened and unfastened from the roller without the use of complex tools, i.e.—by using heat and other similar means.

Additionally, because the present invention eliminates the need for fasteners, such a roller will be easier to refurbish. For example, the roller could be used until studs on the outer surface of a roller are worn to a depth that makes them unusable, the roller can be removed and the outer surface can be turned down so that it is cylindrical and a new set of studs can be installed. This would be difficult, if not impossible to do with a roller having edge wear components with fasteners because the old fastener holes will likely be in an improper location.

Lastly, the invention disclosed herein may provide a stronger connection to the roller by strengthening the connection with autogenous or semi-autogenous material. Edge segments with fasteners tend to have problems where autogenous or semi-autogenous material gradually packs in between the edge segments and the side of the roller and over time a high force back and forth cantilevering action can fatigue the fasteners and cause the joint to fail. In essence, in prior art solutions, over time the autogenous or semi-autogenous material is weakening the edge wear component connection to the roller.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

### LIST OF COMPONENTS

1—roller
2—roller edge
3—roller end
4—outer surface
5—anchor mounting pocket
6—gap
10—edge wear component
11—wear portion
12—anchor portion
13—connection portion
15—inner face of edge wear component
16—outer face of edge wear component
17—first face of anchor portion
18—second face of anchor portion
20—autogenous or semi-autogenous material
21—weld material
22—interface between edge wear components
30—key
31—keyway

1. A roller press comprising:
a roller (1) having a roller edge (2) formed by the intersection of a roller end (3) and an outer surface (4);
an edge wear component (10) provided adjacent to said roller edge (2), the edge wear component further comprising a wear portion (11), an anchor portion (12) and a connection portion (13), the wear portion connected to the anchor portion via a connection portion disposed between the wear portion and the anchor portion;
an anchor mounting pocket (5) located inland of said roller end (3) and being spaced from said roller edge (2) and provided within the roller (1), the anchor mounting pocket (5) being configured to receive the anchor portion (12), the anchor mounting pocket being generally isolated from the roller end (3);
a gap (6) located inland of said roller end (3) and being spaced from said roller edge (2) and provided within the roller (1) adjacent to an inner face of the edge wear component (15), the gap (6) running substantially parallel to an inner face of the edge wear component (15) and the gap configured to receive autogenous or semi-autogenous crushed material (14),
wherein the autogenous or semi-autogenous material is disposed within the gap and the anchor portion is disposed within the anchor mounting pocket to secure the edge wear component to the roller.

2. The roller press according to claim 1, wherein at least a portion of the inner face (15) of the edge wear component (10) is tapered.

3. The roller press according to claim 2, wherein at least a portion of a second face (18) of the anchor portion (12) is tapered in a direction opposite to the taper of the inner face (15) of the edge wear component (10) or a first face of the anchor portion (12).

4. The roller press according to claim 1, wherein a weld material is disposed on an outer face (16) of the edge wear component (10) to further secure the edge wear component (10) to the roller (1) and to reduce or eliminate lateral shifting.

5. The roller press according to claim 1, wherein securing material is disposed within the gap (6) or the anchor mounting pocket (12) to further secure the edge wear component (10) to the roller (1).

6. The roller press according to claim 5, wherein the securing material is glue or epoxy.

7. The roller press according to claim 1, wherein the anchor portion (12) and the connection portion (13) are a unitary piece and the wear portion (11) is separate from the unitary anchor portion (12) and connection portion (13).

8. The roller press according to claim 7, wherein the unitary anchor portion (12) and connection portion (13) are connected to the wear portion (11) via a brazing, welding, soldering, sintering, hot isostatic pressing powdered metallurgy, hot forging, warm compacting, powder forging, metal injection molding, high temperature process, interference fit pressing, gluing, or other means for mechanical bonding.

9. The roller press according to claim 8, wherein the connection portion (13) comprises a key (30) and the wear portion (11) comprises a keyway (31), wherein the key (30) and keyway (31) connect the anchor portion (12) via the connection portion (13) to the wear portion (10) by interference fit pressing.

10. The roller press according to claim 1, wherein the edge wear component (10) comprises a composite material.
